(19) United States
(12) Patent Application Publication
(10) Pub. No.: US 2005/0280768 A1
(43) Pub. Date: Dec. 22, 2005

(54) Method for manufacturing liquid crystal display device

(76) Inventor: Sung Mo Koo, Gyeonggi-do (KR)

Correspondence Address: MCKENNA LONG & ALDRIDGE LLP, 1900 K STREET, NW, WASHINGTON, DC, 20006, US

(21) Appl. No.: 11/152,090

(22) Filed: Jun. 15, 2005

(30) Foreign Application Priority Data
Jun. 16, 2004 (KR) 2004-44424

(51) Int. Cl. G02F 1/1339

(52) U.S. Cl. 349/190

(57) ABSTRACT

A method for manufacturing a liquid crystal display device to simplify a manufacturing process and reduce costs. The method includes simultaneously forming a liquid crystal layer and scattering spacers on one of first and second substrates, applying sealant to a periphery of one of the first and second substrates, and bonding the first and second substrates together.

### CROSS-REFERENCE TO RELATED APPLICATION

This application claims the benefit of Korean Application No. P2004-44424 filed on Jun. 16, 2004, which is hereby incorporated by reference for all purposes as if fully set forth herein.

### BACKGROUND OF THE INVENTION

1. Field of the Invention

The present invention relates to methods for manufacturing a liquid crystal display device. More particularly, the present invention relates to a method for manufacturing a liquid crystal display device that simplifies a manufacturing process and reduces costs.

2. Discussion of the Related Art

Features such as low voltage driving, low power consumption, full color implementation, light weight and compactness as resulted in the fields of application of the liquid crystal display device expanding from watches, calculators, PC monitors, notebook computers to TVs, aeronautical monitors, PDAs, and cellular phones.

In liquid crystal display devices, there is a liquid crystal panel for displaying a picture, and a circuit unit for driving the liquid crystal panel.

The liquid crystal panel includes a first substrate having a thin film transistor array formed thereon, a second substrate having a color filter array formed thereon, and a liquid crystal layer between the two substrates.

On the first substrate having the thin film transistor thereon, there are a plurality of gate lines arranged in one direction at regular intervals, a plurality of data lines arranged perpendicular to the gate lines to define pixel regions, a plurality of pixel electrodes in the pixel regions for displaying a picture, and a plurality of thin film transistors (TFTs) at a portion of each of the pixel regions where the gate lines and the data lines cross the TFTs being turned on/off in response to a driving signal on the gate line to transfer a picture signal from the data line to the pixel electrodes.

On the second substrate having the color filter array thereon, there are a black matrix layer for shielding a light incident on parts except the pixel regions, a R, G, B color filter layer opposite the pixel regions for implementing colors, and a common electrode on an entire surface inclusive of the color filter layer. The common electrode may be formed on the first substrate in a liquid crystal display device of an IPS (In Plane Switching) mode.

The first and second substrates are bonded together with a space therebetween, and a liquid crystal layer is formed between the first and second substrates.

A liquid crystal injection method and a liquid crystal dispensing method may be used to form the liquid crystal layer. The liquid crystal manufacturing process also has difference to some extent depending on above whether the injection or dispensing is used.

FIG. 1 illustrates an exploded perspective view of a related art liquid crystal display device.

In FIG. 1, the related art liquid crystal display device includes a lower substrate 1 and an upper substrate 2 bonded together with a predetermined gap therebetween, and a liquid crystal layer 3 injected between the lower substrate 1 and the upper substrate 2.

On the lower substrate 1, there are a plurality of gate lines 4 arranged in one direction at regular intervals, and a plurality of data lines 5 arranged perpendicular to the gate lines 4 at regular intervals to define pixel regions P, a plurality of pixel electrodes at the pixel regions P where the gate lines 4 and the data lines 5 cross, and a plurality of thin film transistors T at a portion of each of the pixel regions where the gate lines and the data lines cross.

On the upper substrate, there are a black matrix layer 7 for shielding a light incident on parts except the pixel regions, a R, G, B color filter layer 8 for expressing colors, and a common electrode for implementing a picture.

The thin film transistor T includes a gate electrode projected from the gate line 4, a gate insulating film (not shown) formed on an entire surface, an active layer on the gate insulating film over the gate electrode, a source electrode projected from the data line 5, and a drain electrode opposite the source electrode.

The pixel electrode 6 is formed of a transparent conductive metal having comparatively good light transmittivity, such as indium-tin-oxide (ITO).

The foregoing liquid crystal display device expresses a picture as the liquid crystal layer 3 on the pixel electrode 6 is oriented in response to a signal from the thin film transistor T to regulate a quantity of light transmitting through the liquid crystal layer 3.

FIG. 2 is a flow chart showing the steps of a related art method for manufacturing a liquid crystal display device by applying the liquid crystal injection method thereto.

In FIG. 2, a TFT-array (not shown) is formed on a first substrate (1S), and a C/F array (not shown) is formed on a second substrate (5S).

Then, an alignment film is formed on each of the first and second substrates to orient liquid crystals, and rubbed (2S, and 6S), and the first and second substrates are cleaned (3S, and 7S).

Then, spacers are scattered on the first substrate for maintaining a cell gap of a liquid crystal panel (4S), and Ag is coated on a periphery of the second substrate for connecting a common line to the common electrode, and sealant is coated for bonding the first and second substrates.

The first and second substrates (not shown) are placed in a bonding apparatus (not shown) and are bonded together (9S).

Then, the bonded first and second substrates are loaded on a curing furnace (not shown) to cure the sealant (10S).

Upon finishing the curing step, the bonded first and second substrates are scribed, and broken by unit liquid crystal panels (11S), liquid crystals are filled in a space between the first and second substrates in a vacuum chamber by the unit liquid panels, and the liquid crystal injection hole is sealed (12S).

That is, upon putting the liquid crystal injection hole into liquid crystal fluid in a state a vacuum state is maintained between the two substrates bonded with the sealant, the liquid crystals are filled between the two substrates by an osmotic phenomenon. Upon finishing injection of the liquid crystals, the liquid crystal injection hole is sealed with sealant.

Then, the liquid crystal panel is inspected and shipped (13S).

However, the related art liquid crystal injection method requires a long time to inject the liquid crystals which effects productivity because the liquid crystal injection hole is put into liquid crystal fluid and a vacuum state is maintained between the two substrates. Moreover, in manufacturing a large sized liquid crystal panel, the liquid crystal injection by the liquid crystal injection method is liable to cause imperfect injection of the liquid crystals in the liquid crystal panel, to manufacture a defective liquid crystal panel.

Accordingly, most of the liquid crystal panels for cellular phones and PDAs are manufactured by the liquid crystal injection method, while the large sized liquid crystal panels are manufactured by a liquid crystal dispensing method.

A related art method for manufacturing a liquid crystal display device by applying the liquid crystal dispensing method thereto will be described.

FIG. 3 is a flow chart showing the steps of a related art method for manufacturing a liquid crystal display device by applying the liquid crystal dispensing method thereto.

In FIG. 3, a TFT-array is formed on a first substrate (21S), and a C/F array is formed on a second substrate (25S).

In this instance, a plurality of column spacers are formed on the second substrate in formation of the C/F array, to maintain a cell gap. The plurality of column spacers are secured to predetermined positions of the C/F array substrate.

An alignment film is formed on each of the first and second substrates for orienting liquid crystals, rubbed (22S, and 26S), and cleaned (23S, and 27S), respectively.

Then, an appropriate amount of the liquid crystals are dispensed on the first substrate (24S). In this instance, the liquid crystals are dropped on a central portion of each liquid crystal panel regions, and care is taken so that the liquid crystals do not come into contact with the sealant until the sealant is cured completely enough to maintain the cell gap.

Then, sealant and Ag dots are dispensed on a periphery of each of the liquid crystal panel regions of the second substrate (28S). In this instance, the sealant is patterned on each of the liquid crystal panel regions, independently.

The first and second substrates formed thus are placed in a vacuum bonding chamber (not shown) and bonded together (29S).

That is, after positioning the second substrate on an upper stage of the vacuum bonding chamber, with the second substrate inverted so as to make the sealant to face down, the first substrate having the liquid crystals dispensed thereon is positioned on a lower stage. Then, the first, and second substrates are bonded together with the vacuum bonding chamber maintained in a vacuum state.

The first and second substrates bonded are then transferred from the vacuum bonding chamber to an UV curing furnace (not shown), and has a UV beam directed thereto, to cure the sealant (30S).

That is, in order to direct the UV beam only to a portion having the sealant coated thereon, the UV beam is directed to the sealant by using a mask (not shown) having a light shielding film formed at the rest of the substrate, to cure the sealant with the UV beam.

The cured substrate UV is then loaded on a thermal curing furnace to cure the sealant with heat (31S). The liquid crystals on each of the liquid crystal panels start to spread.

Upon finishing the UV beam, and thermal curing steps, the first and second substrates are cut into unit liquid crystal panels (32S), polished by unit liquid crystal panels (33S), and inspected, and shipped (34S and 35S).

The manufacturing of the liquid crystal display device by applying the liquid crystal dispensing method significantly reduces a time period required for injection of the liquid crystals, improves productivity and prevent defects from occurring, which are caused by imperfect injection of the liquid crystals in the case of the large sized liquid crystal display devices.

However, the related art method for manufacturing a liquid crystal display device has the following problems.

The step of forming column spacers on the second substrate separate from the step of dispensing the liquid crystals on the first substrate makes the manufacturing process complicated.

Second, the column spacers are formed by deposition of a photosensitive material on an entire surface of the substrate, and exposing, and developing the photosensitive material to remove the photosensitive material selectively. Consequently, costs are increased and the process is complicated.

### SUMMARY OF THE INVENTION

Accordingly, the present invention is directed to a method for manufacturing a liquid crystal display device that substantially obviates one or more problems due to limitations and disadvantages of the related art.

An advantage of the present invention is to provide a method for manufacturing a liquid crystal display device, in which spacers and a liquid crystal layer are formed at the same time to simplify a manufacturing process and to reduce costs.

Additional advantages and features of the invention will be set forth in part in the description which follows and in part will become apparent to those having ordinary skill in the art upon examination of the following or may be learned from practice of the invention. The advantages of the invention may be realized and attained by the structure particularly pointed out in the written description and claims hereof as well as the appended drawings.

To achieve these and other advantages and in accordance with the purpose of the invention, as embodied and broadly described herein, a method for manufacturing a liquid crystal display device includes simultaneously forming a liquid crystal layer and scattering spacers on one of first and second substrates, applying sealant to a periphery of one of the first and second substrates, and bonding the first and second substrates together.

Forming a liquid crystal layer and scattering spacers on the first substrate at the same time includes mixing the liquid crystals and scattering the spacers at a predetermined ratio, and dispensing a mixture thereof on the first substrate.

In another aspect of the present invention, a method for manufacturing a liquid crystal display device includes forming and rubbing a first alignment film on a first substrate, forming and rubbing a second alignment film on a second substrate, cleaning the first and second substrates, simultaneously forming a liquid crystal layer and scattering spacers on the first substrate, applying Ag dots and a sealant on the second substrate, bonding the first and second substrates together, curing the sealant between the first and second substrates, cutting the bonded first and second substrates into unit panels, and polishing and inspecting each of the unit panels to polishing, and inspection.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates an exploded perspective view of a related art liquid crystal display device;

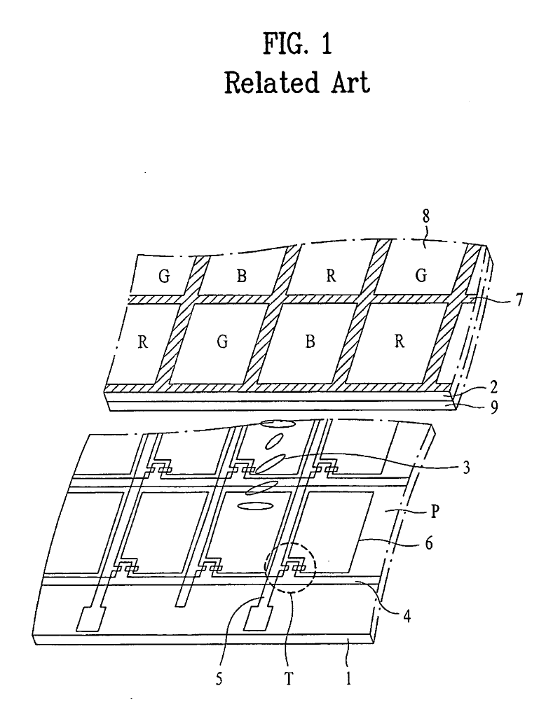

FIG. 2 illustrates a flow chart showing the steps of a related art method for manufacturing a liquid crystal display device by applying the liquid crystal injection method thereto;

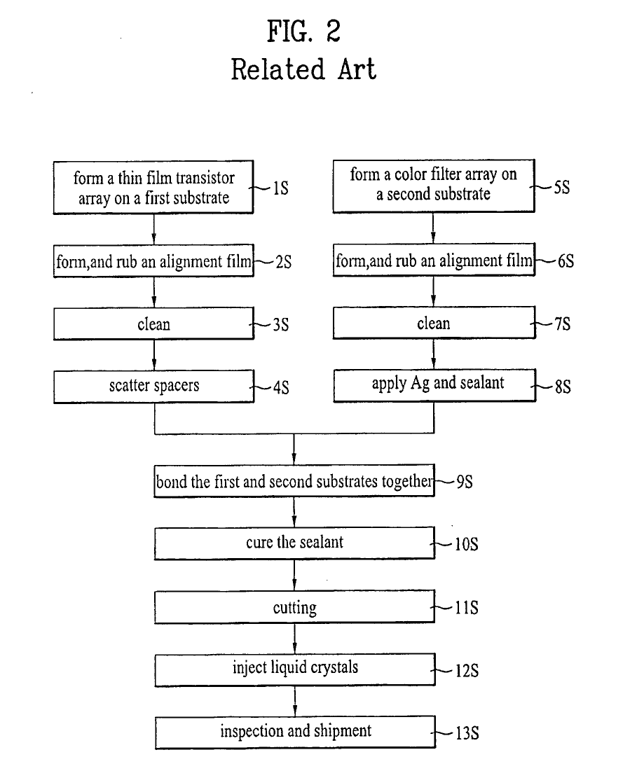

FIG. 3 illustrates a flow chart showing the steps of a related art method for manufacturing a liquid crystal display device by applying the liquid crystal dispensing method thereto; and

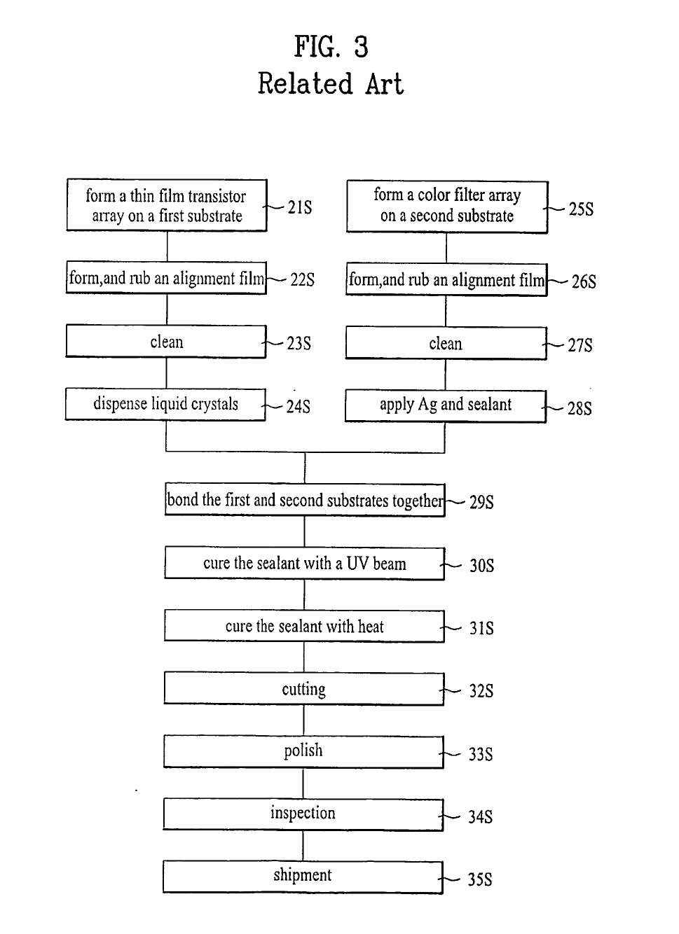

FIG. 4 illustrates a flow chart showing the steps of a method for manufacturing a liquid crystal display device in accordance with an embodiment of the present invention.

### DETAILED DESCRIPTION OF THE ILLUSTRATED EMBODIMENTS

Reference will now be made in detail to embodiments of the present invention, examples of which are illustrated in the accompanying drawings. Wherever possible, the same reference numbers will be used throughout the drawings to refer to the same or like parts.

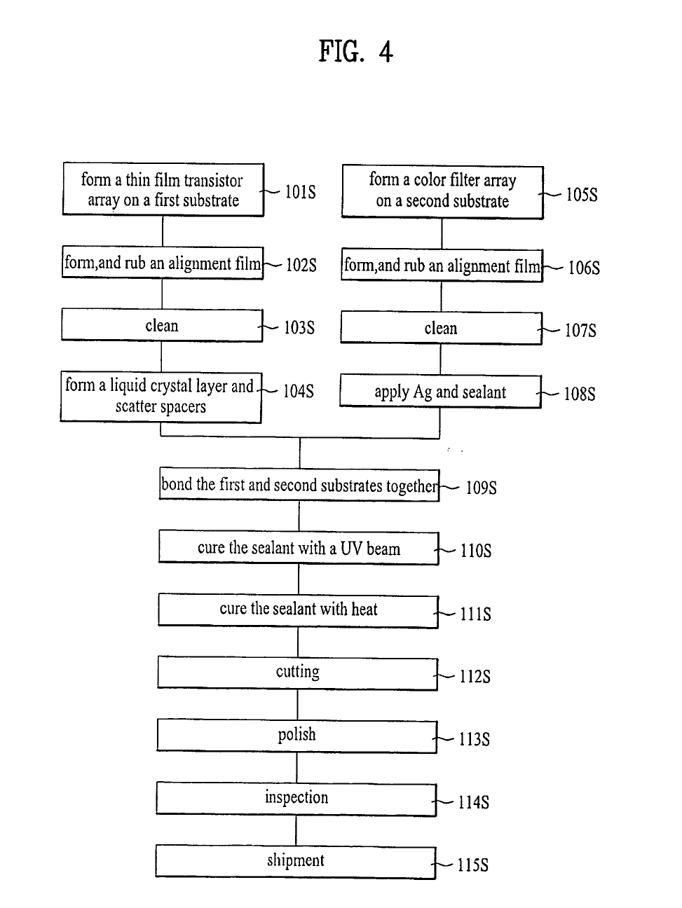

FIG. 4 is a flow chart illustrating a method for manufacturing a liquid crystal display device in accordance with an embodiment of the present invention.

In FIG. 4, a TFT-array (not shown) is formed on a first substrate (101S), and a C/F array (not shown) is formed on a second substrate (105S). In this instance, no column spacers are formed on the second substrate.

On the first substrate, there are a plurality of gate lines arranged in one direction at regular intervals, a plurality of data lines arranged substantially perpendicular to the gate lines at regular intervals, and a plurality of thin film transistors, and pixel electrodes at a matrix of pixel regions defined by the gate lines and the data lines.

On the second substrate, there are a black matrix layer for shielding a light incident on parts except the pixel regions, a color filter layer, and a common electrode.

If the liquid crystal display device is of an IPS mode, the pixel electrodes and the common electrode are formed on the first substrate, and an overcoat layer is formed on the second substrate instead of the common electrode.

Then, the first substrate, and the second substrate are selected respectively using robotic arms programmed to select the first and second substrates, respectively.

Then, an alignment film is formed on each of the first and second substrates for orienting liquid crystals, and rubbed (102S and 106S), and the first and second substrates are cleaned (103S and 107S).

Formation of the alignment film and rubbing proceed in an order of cleaning before coating the alignment film, printing the alignment film, baking of the alignment film, alignment film inspection, and rubbing.

Then, formation of the liquid crystal layer and scattering of the spacers are made at the same time (104S). That is, the spacers and the liquid crystals are mixed at a predetermined ratio to form a mixture thereof, and the mixture is dispensed with a dispensing device to form the liquid crystal layer and to scatter the spacers at the same time.

Then, sealant and Ag dots are applied to a periphery of each of the liquid crystal panel regions of the second substrate (108S). In this instance, the sealant is patterned at each of the liquid crystal panel regions, independently.

The first and second substrates formed in the above manner are placed in a vacuum bonding chamber, having a pressure applied thereto, to bond the two substrates together (109S).

The foregoing bonding process will be described in more detail.

The bonding process of the present invention includes loading two substrates on a vacuum bonding chamber, aligning the two substrates, bonding the two substrates, and unloading the two substrates bonded from the vacuum bonding chamber.

Before loading, the second substrate having the sealant applied thereto may be cleaned at an USC (Ultra Sonic Cleaner), to remove particles formed during the manufacturing process. That is, since the second substrate has no liquid crystals dispensed thereon, but the sealant, and Ag dots applied thereto, the cleaning is possible.

In the loading process, the second substrate having the sealant applied thereto is held at an upper stage of the vacuum bonding chamber with a vacuum, with a side thereof having the sealant applied thereto faced down, and the first substrate having the liquid crystal layer formed thereon, and the spacers scattered thereon are held at a lower stage with a vacuum. The vacuum bonding chamber is, for example, at an atmospheric pressure.

In more detail, a loader of a robot holds and takes the second substrate having the sealant applied thereto into the vacuum bonding chamber, with a side thereof having the sealant applied thereto faced down. In this state, the upper stage of the vacuum bonding chamber moves down and holds the second substrate with a vacuum, and moves back up. Instead of the vacuum, static electricity may be used.

Then, the loader of the robot goes out of the vacuum bonding chamber and places the first substrate, having the liquid crystal layer formed thereon, and the spacers scattered thereon, on the lower stage in the vacuum bonding chamber.

Though it is described that the liquid crystal layer is formed on, and the spacers are scattered on the first substrate having the thin film transistor array formed thereon, and the sealant is applied to the second substrate having the color filter array formed thereon, the sealant may be applied to the first substrate, and the liquid crystal layer may be formed on, and the spacers may be scattered on any one of the two substrates. However, in any case, it is required to place one substrate having the liquid crystal dispensed thereto on the lower stage, and the other substrate on the upper stage.

Then, a substrate receiver is brought to a position right under the second substrate held at the upper stage, according to the following method.

First, the upper stage is moved down, or the substrate receiver is moved up, until the second substrate and the substrate receiver are in close proximity, when the second substrate is placed on the substrate receiver.

Second, the upper stage is moved down a certain distance, and the substrate receiver is moved up, such that the second substrate and the substrate receiver come closer, and then, the second substrate is placed on the substrate receiver.

Third, the upper stage is moved down, or the substrate receiver is moved up, or the upper stage is moved down at first, and the substrate receiver is moved up next, such that the second substrate and the substrate receiver come close at a certain distance, and then, the upper stage keeps holding the second substrate by a vacuum.

The substrate receiver is brought under the second substrate to prevent the second substrate held at the upper stage by a vacuum from falling off the upper stage, and dropping on the first substrate as the stages lose the vacuum during evacuation of the vacuum bonding chamber to a vacuum higher than the vacuum of the stages in a state the stages hold the first, and second substrates by vacuum.

Therefore, the second substrate held at the upper stage may be placed on the substrate receiver before evacuation of the bonding chamber, or the upper stage holding the second substrate by the vacuum and the substrate receiver are positioned at a distance, so that the second substrate is placed on the substrate receiver from the upper stage during evacuation of the bonding chamber.

There may be additional holding means for holding the substrate to prevent the substrate from moving at an initial stage due to air flow in the chamber upon starting of evacuation of the bonding chamber.

If the upper and lower stages hold the first and second substrates by static electricity, the evacuation can be made directly without bringing the substrate receiver under the upper stage.

The vacuum bonding chamber is evacuated to a vacuum state. Though the vacuum of the vacuum bonding chamber varies with liquid crystal modes intended to bond, the vacuum in the IPS mode is about 1.0×10⁻³ Pa˜1 Pa, and the vacuum in the TN mode is about 1.1×10⁻³ Pa˜10² Pa.

The vacuum chamber may be evacuated in two stages. That is, after holding the substrates with the upper and lower stages, respectively, and closing a door on the chamber, a primary evacuation is performed. Then, after the substrate receiver is brought under the upper stage, and the substrate held at the upper stage is placed on the substrate receiver, or after the upper stage and the substrate receiver are brought to be spaced a certain distance in a state the substrate is held by vacuum, a secondary evacuation is performed. In this instance, the secondary evacuation is faster than the primary evacuation, and the vacuum of the vacuum bonding chamber in the primary evacuation is made to be lower than the vacuum of the upper stage.

Alternatively, the evacuation may not be divided into two, but the evacuation may be performed uniformly after the substrates are held at respective stages and the door on the chamber is closed, during which the substrate receiver is brought under the upper stage. In this instance, it is required that the substrate receiver is brought under the upper stage is before the vacuum of the vacuum bonding chamber is higher than the vacuum of the upper stage.

The evacuation of the vacuum bonding chamber is performed in two stages, to prevent the substrate in the vacuum chamber from distorting or becoming out of position due to rapid evacuation of the vacuum bonding chamber.

Once the vacuum bonding chamber reaches a certain vacuum, the upper and lower stages hold the first and second substrates by a static electricity absorption method, and the substrate receiver is returned to an original position.

In the static electricity absorption method, +/−DC currents are applied to at least two flat electrodes on the stage to hold the substrate. That is, upon application of a “+”, or “−” voltage to the flat electrode, a “+” or “−” charge is induced at the stage, such that the substrate is absorbed to the stage by a Coulomb force generated between a conductive layer (transparent electrode such as the common electrode or pixel electrodes) on the substrate and the stage.

If a side of the substrate having the conductive layer formed thereon faces the stage, a voltage in a range of about 0.1˜1 KV is applied, and if a side of the substrate having the conductive layer formed thereon faces away from the stage, a voltage in a range of about 3˜4 KV is applied. An elastic sheet may be provided on the upper stage.

In the process of aligning the two substrates, the upper stage is moved downward so that the second substrate comes closer to the first substrate, the first and second substrates are aligned.

A method for aligning the substrates will be described in detail.

A plurality of rough align marks (approx. 3 μm size) and fine align marks (approx. 0.3 μm size) may be carved in predetermined positions of the first and second substrates, respectively.

Cameras for aligning the rough align marks, and cameras for aligning the fine align marks are separately mounted on the vacuum bonding apparatus. The cameras are mounted separately because it is difficult to align both the rough align marks and the fine align marks with only one camera because the rough align mark and the fine align mark are different sizes and positions. Each of the cameras is focused at the middle of the first and second substrates.

Therefore, at first, the upper stage is moved down until a gap between the first, and second substrates is in a range of about 0.4 mm˜0.9 mm (preferably, approx. 0.6 mm), and the first substrate and the second substrate are aligned such that the rough align mark in the second substrate is positioned in the rough align mark in the first substrate. Next, the upper stage is moved down until the gap between the first, and second substrates is in a range of about 0.1 mm ˜0.4 mm (preferably, approx. 0.2 mm), and the first substrate and the second substrate are finely aligned such that the fine align mark in the second substrate is positioned exactly in the fine align mark in the first substrate.

In the alignment of the small align marks, the liquid crystals on the first substrate may be brought into contact with the second substrate.

Since it is designed that the upper stage moves up/down and the lower stage moves in X and Y-axis directions, the lower stage is moved in the alignment of the two substrates.

In methods for aligning the rough align marks and the small align marks, there is a first method in which the alignment is made by focusing at the middle of the gap between the mark in the second substrate and the mark in the first substrate with the camera mounted on an upper side or a lower side of the substrate, and there is a second method in which the mark in the second substrate and the mark in the first substrate are focused alternately by shifting a focal point of the camera to improve precision.

Numbers of the rough align marks and the fine align marks in the first and second substrates are four or more than four, respectively, which may be increased to improve precision of the alignment following the size of the substrate becomes greater. The rough align marks and the fine align marks are formed at positions between panels which are to be cut away, or edges of an original substrate having the plurality of panels formed thereon.

The alignment of the first and second substrates with different cameras in the alignment of the rough align marks and the fine align marks enables fast and accurate alignment.

Upon finishing alignment of the two substrates thus, in a state the two substrates are held at respective stages, the upper stage is moved down, and presses down the first and second substrates to bond the two substrates. In this instance, the upper stage or the lower stage is moved in a vertical direction, while varying a speed and a pressure of the stage. The stage is moved at a fixed speed or pressure until the liquid crystals and the spacers on the first substrate come into contact with the second substrate, or the sealant both on the first and second substrates come into contact when the pressure is increased step by step until a desired final pressure is reached. That is, a load cell is mounted on a shaft of the stage for sensing a time of contact, so that the two substrates are bonded with a pressure of 0.1 ton at the time of contact, 0.3 ton at an intermediate stage, 0.4 ton at a final stage, and 0.5 ton at an end stage.

Though the upper stage presses down the substrates with one shaft, a plurality of shafts may be provided, each with a load cell mounted thereon, for independent application of the pressure with each of the shafts. Accordingly, if the lower stage and the upper stage are not leveled accurately, to cause failure in even bonding of the sealant, a pertinent shaft is made to apply a relatively higher or lower pressure for even bonding of the sealant.

Upon finishing bonding of the two substrates, the holding by the static electricity absorption method stops, and the upper stage is moved up to separate the upper stage from the bonded two substrates.

Then, the bonded substrates are unloaded. That is, upon finishing the bonding, either the upper stage is moved up, and the bonded first and second substrates are unloaded by using the loader of the robot, or the upper stage is moved up, holding the bonded first and the second substrates, and the loader of the robot unloads the first and second substrates from the upper stage.

In order to shorten a process time period, it is possible that one of the first or second substrates to be bonded at the next time is loaded on the stage and the bonded first and second substrates may be unloaded. That is, after the second substrate, of which bonding process is to be performed at the next cycle, is positioned at the upper stage by using the loader of the robot, and the upper stage is made to hold the second substrate by a vacuum, the first and second substrates on the lower stage is unloaded, or after the upper stage holds the bonded first and second substrates, and moves up, and the loader of the robot loads the first substrate of which bonding process is performed at the next time on the lower stage, the bonded first and second substrates may be unloaded.

The first and second substrates bonded thus are transferred from the vacuum bonding chamber to a UV curing furnace (not shown), and have a UV beam applied thereto for curing the sealant (110S).

That is, the UV beam is applied to the sealant to cure the sealant using a mask (not shown) having a light shield film formed at a portion except portions having the sealant formed thereon for applying the UV beam to the portions, selectively.

Then, the substrate cured by the UV beam is loaded on a thermal curing furnace, and the sealant is cured with heat (111S). In this instance, the liquid crystals on the liquid crystal panel start to spread.

Upon finishing the UV beam and thermal curing processes, the first and second substrates are cut into unit liquid crystal panels (112S), each of which is polished (113S), inspected (114S), and shipped (115S).

In dispensing the liquid crystals in the present invention, spacers may be mixed with the liquid crystals in advance, the mixture of the liquid crystals and the spacers are dispensed on a large sized glass substrate directly by using the dispensing device, and the dispensed liquid crystals are distributed evenly throughout an entire panel, and, at the same time, a constant gap between the two substrates is formed with the pressure applied to the substrates.

That is, before bonding the first and second substrates, the liquid crystals and the spacers are mixed on the first substrate, and the mixture of the liquid crystal and the spacers are dispensed with the dispensing device.

The first and the second substrates are bonded as the sealant is applied to a periphery of the second substrate, and a pressure is applied to the first and second substrates, and, at the same time, the liquid crystals spreads to an outer region by the pressure, to form a liquid crystal layer between the second substrate and the first substrate, evenly.

In the meantime, though it is described that both the liquid crystal layer is formed, and the spacers are scattered, on the first substrate, and both the sealant and the Ag dots are applied to the periphery of each of the liquid crystal panel regions of the second substrate, all of the liquid crystal formation, the spacer scattering, and the sealant and Ag dot application may be done on any one of the two substrates.

That is, the mixture of the liquid crystals and the spacers may be dispensed on each of the liquid crystal panel regions of one of the first and second substrates, and the sealant and the Ag dots may be applied to the peripheries of the liquid crystal panel regions of the same substrate.

The direct dispensing of liquid crystal on the substrate within a short time in such a liquid crystal dispensing method, not only enables very quick formation of the liquid crystal layer for large sized liquid crystal display devices, but also minimizes consumption of the liquid crystals owing to direct dispensing of a required amount of liquid crystals only, thereby substantially reducing production costs of the liquid crystal display device.

As has been described, the method for manufacturing a liquid crystal display device has the following advantages. That is, the simultaneous formation of the liquid crystal layer and spacers scattering using a mixture of the liquid crystals and the spacers simplifies the manufacturing process, solves problems relating to space limitations, and reduces costs.

It will be apparent to those skilled in the art that various modifications and variations can be made in the present invention without departing from the spirit or scope of in inventions. Thus, it is intended that the present invention cover the modifications and variations of the invention provided they come within the scope of the appended claims and their equivalents.

1. A method for manufacturing a liquid crystal display device, comprising:
simultaneously forming a liquid crystal layer and scattering spacers on one of first and second substrates;
applying sealant to a periphery of one of the first and second substrates; and
bonding the first and second substrates together.

2. The method as claimed in claim 1, wherein the first substrate is a thin film transistor array substrate.

3. The method as claimed in claim 1, wherein the second substrate is a color filter substrate.

4. The method as claimed in claim 1, wherein simultaneously forming a liquid crystal layer and scattering spacers on one of the first and second substrates includes mixing liquid crystals and scattering spacers at a predetermined ratio, and dispensing the mixture on the first substrate.

5. The method as claimed in claim 1, wherein both the liquid crystal layer is formed and the spacers are scattered on the first substrate, and the sealant is applied to the second substrate.

6. The method as claimed in claim 1, wherein the forming the liquid crystal layer formation, the scattering spacers, and the applying sealant are all done on one of the first and second substrates.

7. The method as claimed in claim 1, further comprising forming an alignment film on each of the first and second substrates, and rubbing the alignment films before the forming of the liquid crystal layer, the scattering spacers, and the applying sealant.

8. The method as claimed in claim 1, further comprising curing the sealant after the bonding of the first and second substrates together.

9. A method for manufacturing a liquid crystal display device, comprising:
forming and rubbing a first alignment film on a first substrate;
forming and rubbing a second alignment film on a second substrate;
cleaning the first and second substrates;
simultaneously forming a liquid crystal layer and scattering spacers on the first substrate;
applying Ag dots and a sealant one the second substrate;
bonding the first and second substrates together;
curing the sealant between the first and second substrates;
cutting the bonded first and second substrates into unit panels; and
polishing and inspecting each of the unit panels.
